(19) United States
(12) Patent Application Publication
(10) Pub. No.: US 2018/0056411 A1
(43) Pub. Date: Mar. 1, 2018

(54) IRIS-TYPE SEGMENTING MECHANISM

(71) Applicant: Baker Perkins Inc., Grand Rapids, MI (US)

(72) Inventors: Peter Harris, Stamford (GB); James E. Jett, II, Lamont, MI (US); Paul Edward Mason, Werrington (GB); David Rhodea, Allendale, MI (US); Jason Alan Smith, Portage, MI (US)

(21) Appl. No.: 15/619,878

(22) Filed: Jun. 12, 2017

Related U.S. Application Data
(60) Provisional application No. 62/381,227, filed on Aug. 30, 2016.

(51) Int. Cl. B23D 45/08; B23D 61/18; B23D 61/08; B23D 45/00; B23D 45/10; B23D 45/14

(52) U.S. Cl. CPC B23D 45/08; B23D 61/18; B23D 45/143; B23D 45/003; B23D 45/10; B23D 61/08

(57) ABSTRACT

A segmenting mechanism includes outer and inner frame members that define a sliding space and an aperture extending therethrough. A first set of sliding blades operates linearly and proximate the aperture. A second set of sliding blades is positioned in an alternating configuration with the first set of sliding blades and also operates linearly within the sliding space proximate the aperture. Each sliding blade of the first and second sets of sliding blades operates cooperatively and simultaneously along each dedicated linear path from a start position, through a medial position to an end position. The start and end positions are each defined by the sliding blades being outside of the aperture to define respective first and second open states of the aperture. The medial position is defined by the sliding blades being at least partially within the aperture to define a closed state of the aperture.

### CROSS-REFERENCE TO RELATED APPLICATION

This application claims priority to and the benefit under 35 U.S.C. §119(e) of U.S. Provisional Patent Application No. 62/381,227, filed on Aug. 30, 2016, entitled “IRIS-TYPE SEGMENTING MECHANISM,” the entire disclosure of which is hereby incorporated herein by reference.

### FIELD OF THE INVENTION

The present invention generally relates to a segmenting mechanism, and more specifically, a segmenting mechanism having an iris-type configuration for segmenting extruded material that is passed through an aperture.

### BACKGROUND OF THE INVENTION

When cutting an extruded-type material, these materials can be passed through an aperture where a segmenting mechanism surrounds a flow of the extruded material and slices the material into predefined sections. Certain configurations of these type of cutters can move concentrically placed blades that open and close simultaneously.

### SUMMARY OF THE INVENTION

According to one aspect of the present invention, an iris separator includes outer and inner frame members that define a sliding space and an aperture extending through the outer and inner frame members. A first set of sliding blades operates linearly within the sliding space and substantially proximate the aperture. A second set of sliding blades is positioned in an alternating configuration with the first set of sliding blades. The second set of sliding blades also operates linearly within the sliding space proximate the aperture. Each sliding blade of the first and second sets of sliding blades operates within the sliding space along a dedicated linear path. The first and second sets of sliding blades cooperatively and simultaneously operate along each dedicated linear path from a start position, through a medial position to an end position. The start and end positions are each defined by the sliding blades of the first and second sets of sliding blades being outside of the aperture to define respective first and second open states of the aperture, the medial position defined by the sliding blades of the first and second sets of sliding blades being at least partially within the aperture to define a closed state of the aperture.

According to another aspect of the present invention, a segmenting mechanism includes a base member having a plurality of openings defined therein and a plurality of iris separators. Each iris separator is positioned at a dedicated opening of the plurality of openings. Each iris separator includes an outer frame member that partially defines a sliding space. The outer frame member includes an aperture that aligns with a dedicated opening of the base member. First and second sets of sliding blades operate linearly within the sliding space and substantially proximate the aperture, wherein sliding blades of the first and second sets of sliding blades are positioned in an alternating configuration relative to the aperture. Each sliding blade of the first and second sets of sliding blades operates within the sliding space along a dedicated linear path. The first and second sets of sliding blades cooperatively and simultaneously operate along each dedicated linear path from a start position, through a medial position to an end position to sequentially define first open, closed and second open states of the aperture.

According to another aspect of the present invention, an iris separator includes an outer frame member that partially defines a sliding space. First and second sets of sliding blades operate linearly within the sliding space and substantially proximate an aperture defined within the outer frame. Each sliding blade of the first and second sets of sliding blades operates along a dedicated linear path. The first and second sets of sliding blades cooperatively and simultaneously operate along each respective dedicated linear path from a start position corresponding to a first open state of the aperture, through a medial position corresponding to a closed state of the aperture and to an end position corresponding to a second open state of the aperture.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a top perspective view of an extruding and separating mechanism incorporating an aspect of an iris separator;

FIG. 2 is a top plan view of a segmenting mechanism incorporating a plurality of iris separators;

FIG. 3 is a side elevational view of the segmenting mechanism of FIG. 2;

FIG. 4 is a bottom plan view of the segmenting mechanism of FIG. 2 with a bottom cover plate with one of the iris separators removed;

FIG. 5 is an enlarged bottom plan view of the segmenting mechanism of FIG. 4 taken at area IV;

FIG. 6 is an exploded perspective view of an iris separator;

FIG. 7 is a series of top perspective views of the segmenting mechanism of FIG. 2 exemplifying operation of the iris separator;

FIG. 8 is a top perspective view of the segmenting mechanism of FIG. 7 showing the iris separator in a first open position;

FIG. 9 is a top perspective view of the segmenting mechanism of FIG. 8 showing the iris separator in a closed position;

FIG. 10 is a top perspective view of the segmenting mechanism of FIG. 9 showing the iris separator in a second open position;

FIG. 11 is a top plan view of an aspect of the iris separator showing the outer frame removed and the iris separator in a first open position;

FIG. 12 is a top plan view of the iris separator of FIG. 11 showing the iris separator in a partially closed position;

FIG. 13 is a top plan view of the iris separator of FIG. 12 showing the iris separator in a closed position;

FIG. 14 is a top plan view of the iris separator of FIG. 12 showing the iris separator in a partially open position;

FIG. 15 is a top plan view of the iris separator of FIG. 14 showing the iris separator in a second open position;

FIG. 16 is a top perspective view of an aspect of a linear actuator guide for operating the segmenting mechanism of FIG. 4;

FIG. 17 is a top perspective view of an aspect of a segmenting mechanism incorporating a plurality of iris separators;

FIG. 18 is a bottom perspective view of the segmenting mechanism of FIG. 17;

FIG. 19 is a side elevational view of the segmenting mechanism of FIG. 17; and

FIG. 20 is a top perspective view of the segmenting mechanism of FIG. 17.

### DETAILED DESCRIPTION OF THE PREFERRED EMBODIMENTS

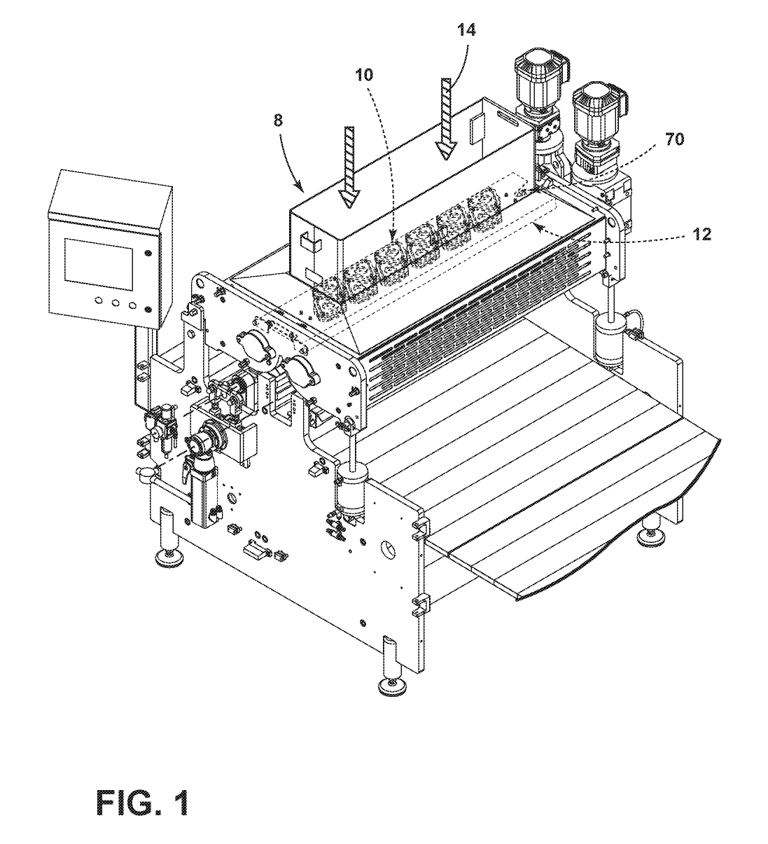

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

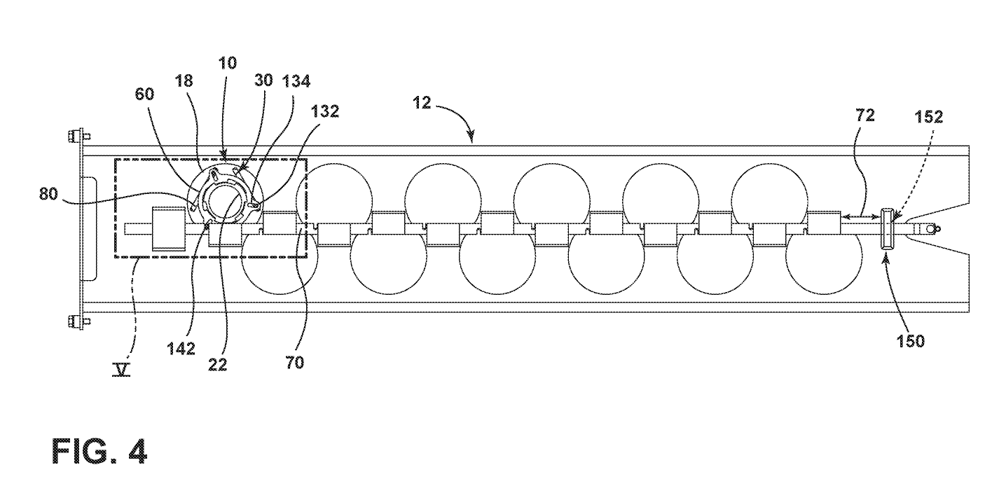

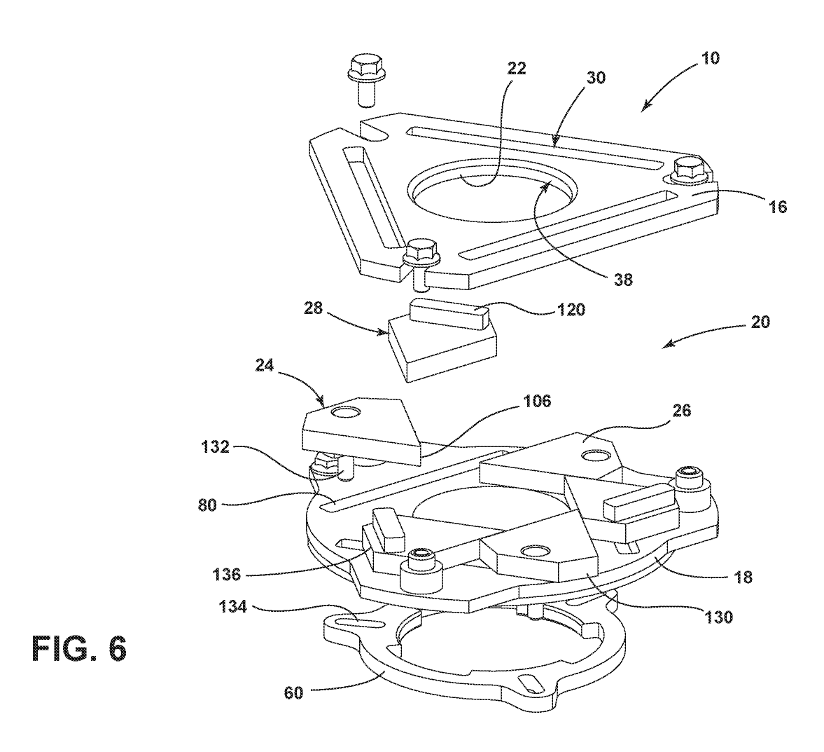

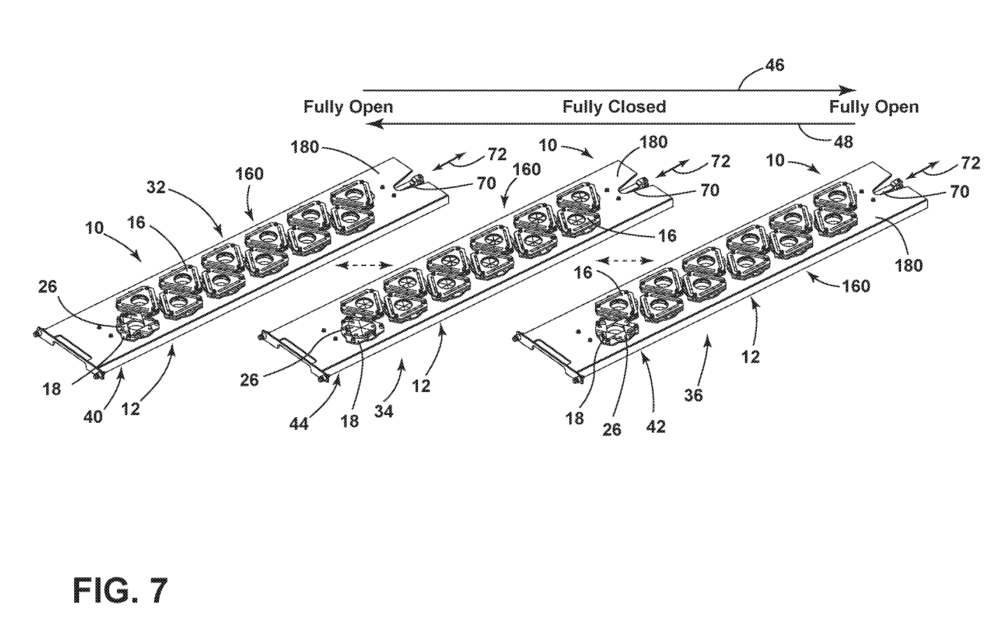

As shown in FIGS. 1-7, reference numeral 10 generally refers to an iris separator that can be disposed within a segmenting mechanism 12 of an extruding and separating mechanism 8 where a plurality of iris separators 10 are set with a predetermined configuration for simultaneous operation to segment, cut, or otherwise separate a plurality of corresponding extruded material streams 14. Each material stream 14 is adapted to be segmented by a dedicated iris separator 10 within the segmenting mechanism 12. According to the various embodiments, each iris separator 10 of the segmenting mechanism 12 can include outer and inner frame members 16, 18 that define a sliding space 20 therebetween and an aperture 22 extending through the outer and inner frame members 16, 18. A first set 24 of sliding blades 26 are adapted to operate linearly within the sliding space 20 proximate or substantially proximate the aperture 22. A second set 28 of sliding blades 26 are positioned in an alternating configuration between the first set 24 of sliding blades 26. The second set 28 of sliding blades 26 also operates linearly within the sliding space 20 proximate the aperture 22. It is contemplated that each sliding blade 26 of the first and second sets 24, 28 operate within the sliding space 20 and along a dedicated linear path 30.

According to the various embodiments, each dedicated linear path 30 is oriented at a different angular configuration with respect to the aperture 22 of the iris separator 10. The first and second sets 24, 28 of sliding blades 26 cooperatively and simultaneously operate along each dedicated linear path 30 from a start position 32, through a medial position 34 and to an end position 36. The start and end positions 32, 36 are each defined by the first and second sets 24, 28 of sliding blades 26 being positioned outside of a boundary 38 defined by the aperture 22, thereby defining the separate respective first and second open states 40, 42 of the aperture 22. The medial position 34 of the first and second sets 24, 28 of sliding blades 26 is defined by each sliding blade 26 of the first and second sets 24, 28 being at least partially within the aperture 22 and defining a closed state 44 of the aperture 22. Accordingly, the outward movement 46 of each sliding blade 26 from the start position 32 to the end position 36 consecutively defines a first open state 40, a closed state 44, and then the second open state 42. Each of the sliding blades 26 is then adapted to reverse course to define a return movement 48 from the end position 36 back to the start position 32. Along this return movement 48 from the end position 36 to the start position 32, the sliding blades 26 cooperatively and simultaneously define, sequentially, the second open state 42, the closed state 44 and the first open state 40.

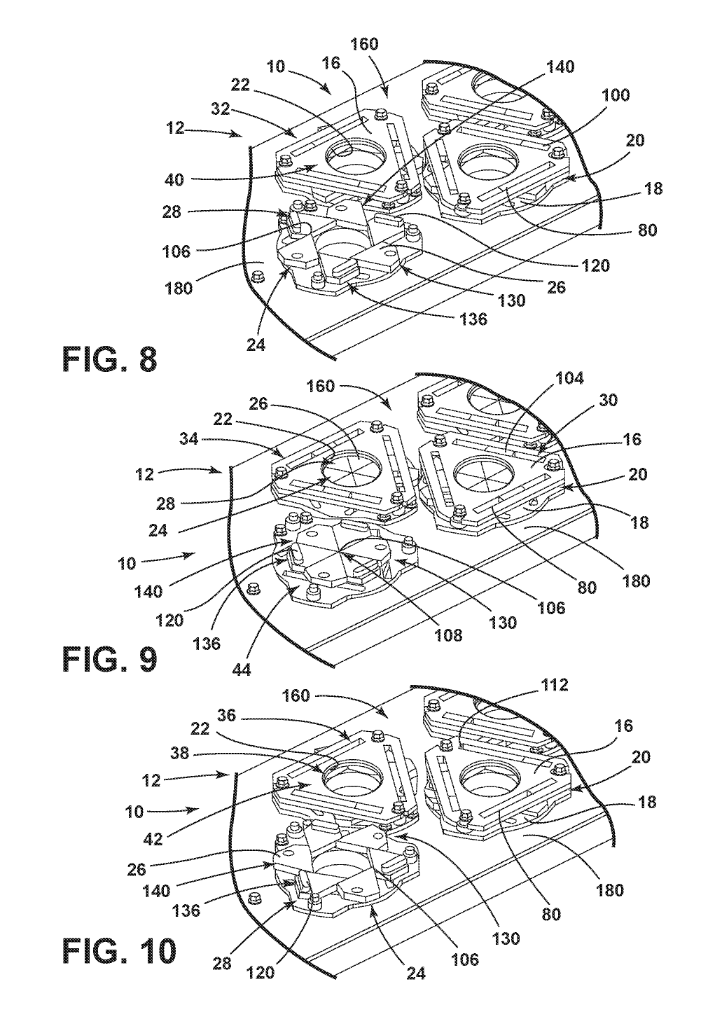

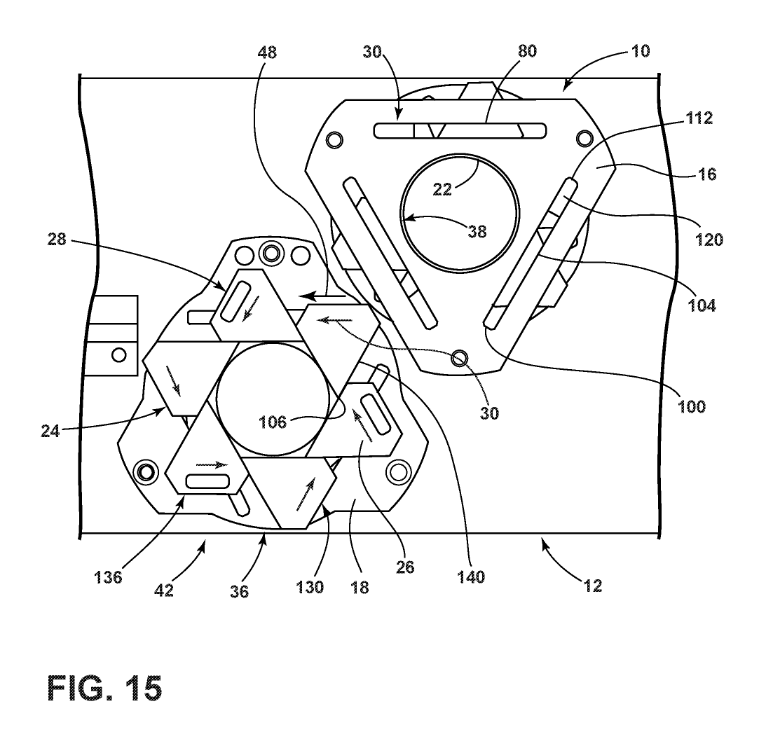

As exemplified in FIGS. 1-15, these outward and return movements 46, 48 of the sliding blades 26 of the first and second sets 24, 28, from the start position 32 to the end position 36 and back to the start position 32, defines a single cycle of the iris separator 10. This single cycle of the iris separator 10 defines two distinct occurrences of the closed state 44 of the aperture 22. Each occurrence of the closed state 44 corresponds to a segmenting operation of the iris separator 10. The segmenting operation is used to segment, cut, or otherwise separate the extruded material stream 14 into predetermined sections. The material stream 14 can be any one of various viscous materials that can include dough, putty, various extruded food products and other viscous extrudable materials.

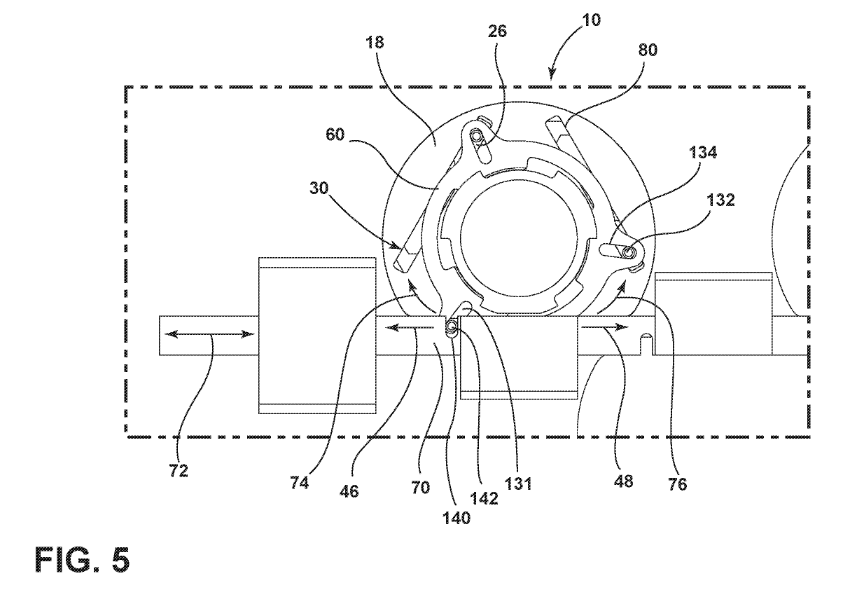

Referring again to FIGS. 5-7, the iris separator 10 can include a radial actuator 60 that engages one of the first and second sets 24, 28 of sliding blades 26. It is contemplated that a single reciprocal rotation of the radial actuator 60 operates the first and second sets 24, 28 of sliding blades 26 through the outward and return movements 46, 48 from the start position 32 to the end position 36 and back to the start position 32. As discussed above, the single reciprocal rotation of the radial actuator 60 defines two distinct occurrences of the closed state 44 of the aperture 22. It is contemplated that the operation of the radial actuator 60 within a single reciprocal rotation corresponds to a single cycle of the sliding blades 26 of the first and second sets 24, 28 of sliding blades 26 through the outward and return movements 46, 48.

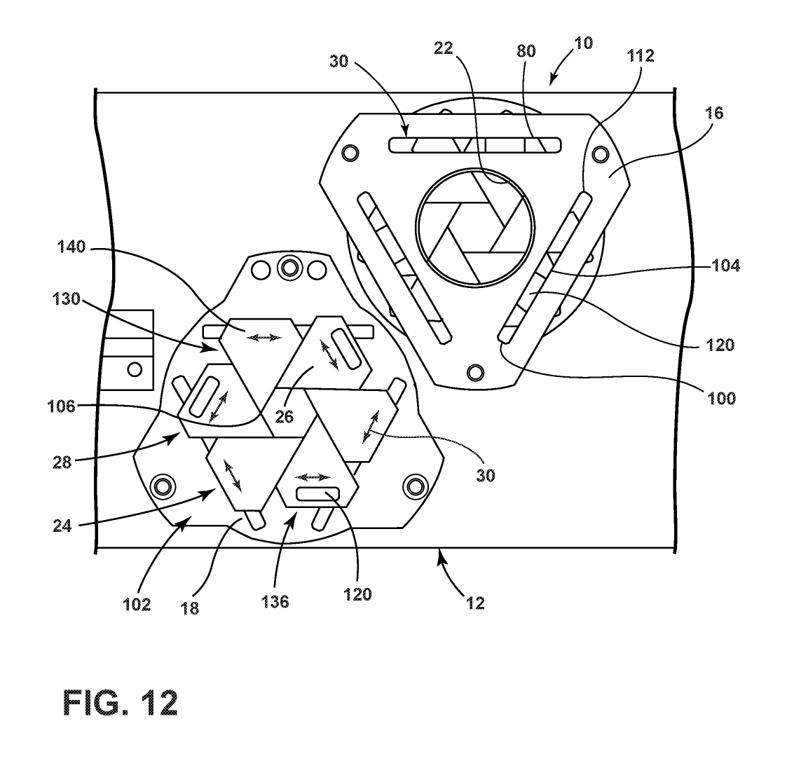

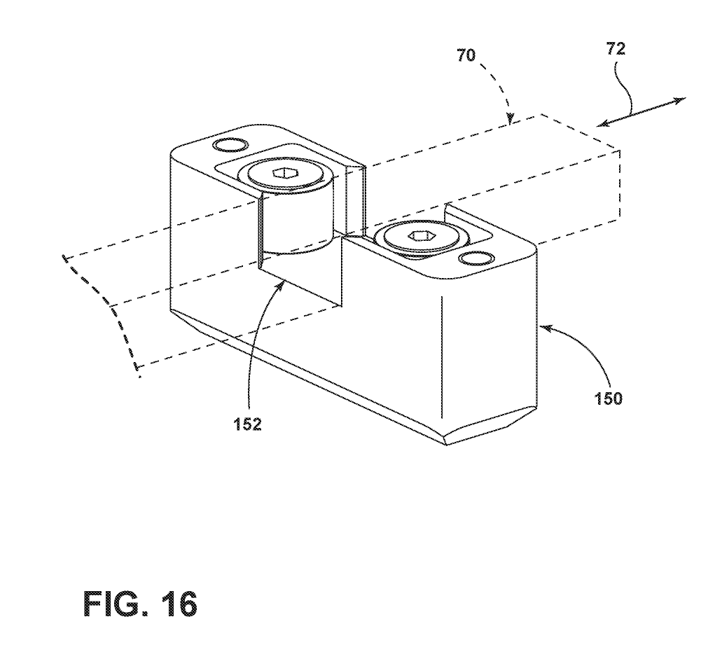

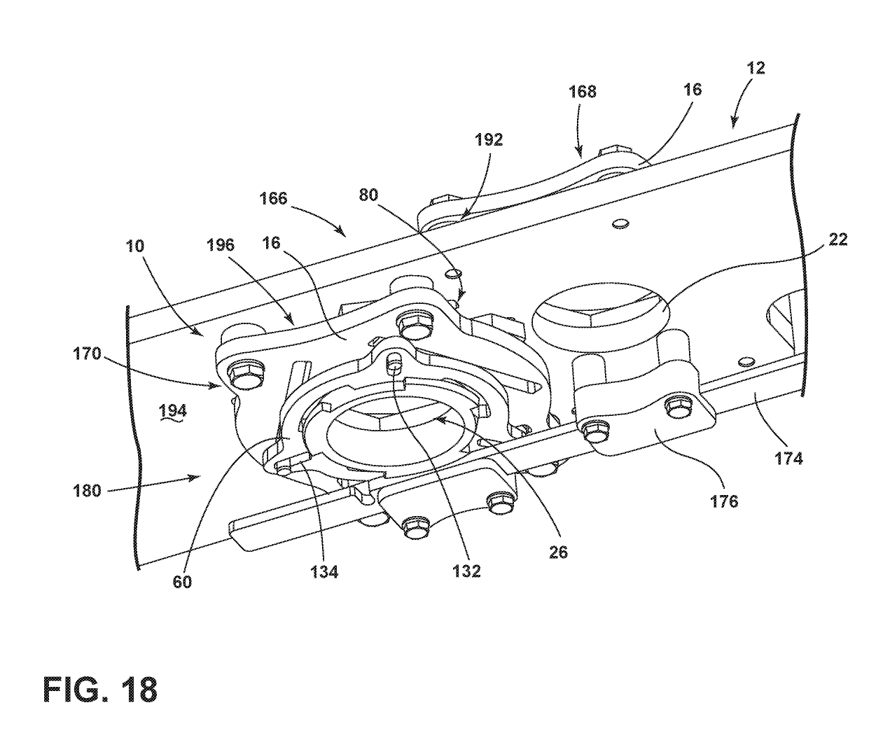

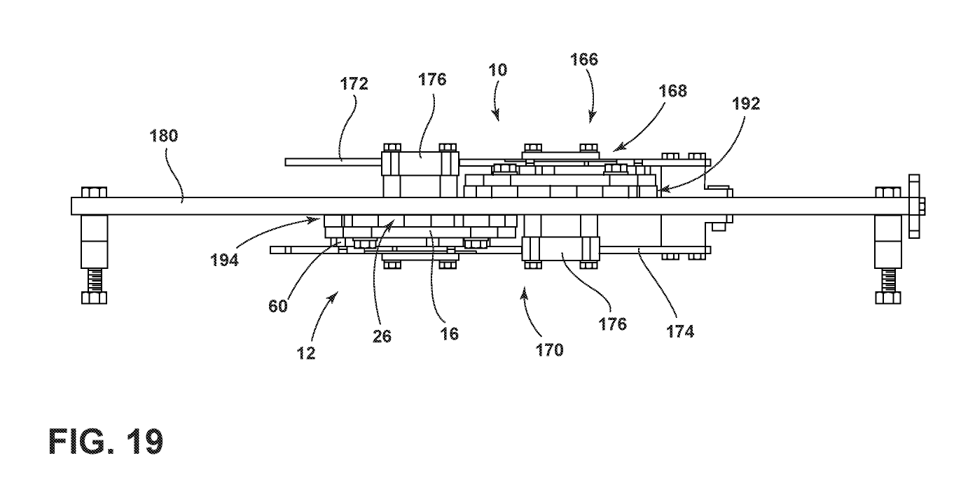

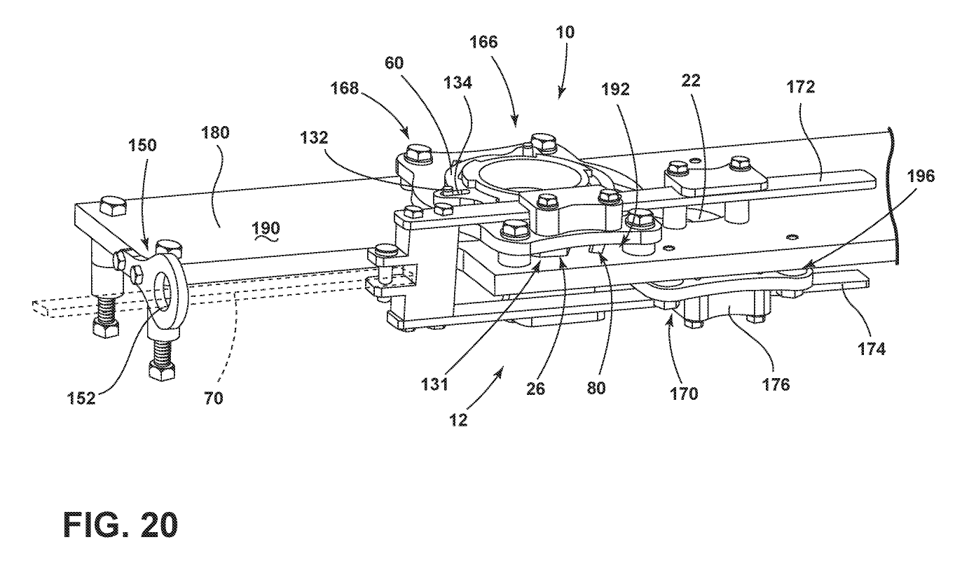

Referring now to FIGS. 12-20, it is contemplated that a plurality of iris separators 10 can be placed in a single segmenting mechanism 12 such that a plurality of extruded material streams 14 can be simultaneously segmented into predetermined sections. Each radial actuator 60 of the plurality of iris separators 10 can be coupled to a linear actuator 70. The linear actuator 70 is coupled to each radial actuator 60, wherein operation of the linear actuator 70 along a linear drive path 72 operates the radial actuator 60 to define reciprocal rotations of the radial actuator 60. Accordingly, a reciprocal movement of the linear actuator 70 corresponds to a forward rotation 74 of the radial actuator 60 that operates the outward movement 46 of each sliding blade 26 of the first and second sets 24, 28 from the start position 32 through the medial position 34 to the end position 36. Continued reciprocal operation of the linear actuator 70 causes a rearward rotation 76 of each radial actuator 60 of the various iris separators 10 that operates the first and second sets 24, 28 of sliding blades 26 in the return movement 48 from the end position 36 back through the medial position 34 and returning to the start position 32. In this manner, a single reciprocal operation of the linear actuator 70 along the drive path 72 results in the forward and rearward rotation 74, 76 that defines the single reciprocal rotation of the radial actuator 60. As discussed above, the single reciprocal rotation results in the two distinct occurrences of the closed state 44 of the aperture 22. Accordingly, one cycle of the linear actuator 70 results in two segmenting operations that can thereby increase the efficiency of the segmenting mechanism 12 and decrease wear and tear on components of the segmenting mechanism 12 during operation.

Referring again to FIGS. 5-15, within the various iris separators 10, each sliding blade 26 of the first and second sets 24, 28 includes a dedicated linear path 30 along which each sliding blade 26 operates during the single reciprocal rotation of the radial actuator 60. It is contemplated that each dedicated linear path 30 for each sliding blade 26 is characterized by a distinct guide slot 80 that is defined within either the outer or inner frame members 16, 18. It is further contemplated that each sliding blade 26 of the first set 24 operates linearly through distinct slots defined within one of the outer and inner frame members 16, 18. Similarly, each sliding blade 26 of the second set 28 is adapted to operate linearly through a guide slot 80 defined within the other of the outer and inner frame members 16, 18.

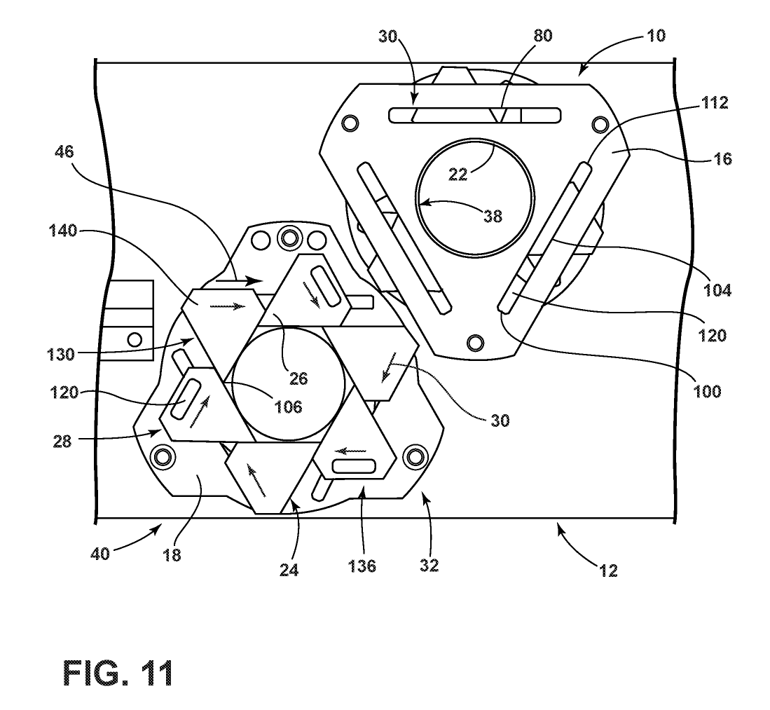

As exemplified in FIGS. 11-15, the guide slots 80 defined within the inner frame member 18 at least partially overlap with the guide slots 80 defined within the outer frame member 16. Accordingly, the guide slots 80 that correspond to the first and second sets 24, 28 of sliding blades 26, respectively, are separated between the outer and inner frame members 16, 18 to define the distinct and dedicated linear path 30 for each sliding blade 26 of the first and second sets 24, 28. To further guide the operation of the sliding blades 26 of the first and second sets 24, 28, each sliding blade 26 is disposed within and operates within the single sliding plane 90 (shown in FIG. 3) defined within the sliding space 20 between the outer and inner frame members 16, 18. It is contemplated that the sliding plane 90 is substantially parallel or is parallel with one or both of the outer and inner frame members 16, 18. During operation of each of the sliding blades 26 between the start position 32 and end position 36 and back to the start position 32, each sliding blade 26 is adapted to slide within the sliding space 20 between the outer and inner frame members 16, 18. Accordingly, the outer and inner frame members 16, 18 substantially contain each sliding blade 26 within the sliding space 20 and, in conjunction with each guide slot 80, limits the operation of each sliding blade 26 to be only within the respective dedicated linear path 30 for each sliding blade 26. In this manner, the outer and inner frame members 16, 18 contain each sliding blade 26 within the sliding space 20 and prevent operation of each sliding blade 26 in a direction perpendicular to the outer and inner frame members 16, 18. Additionally, the various guide slots 80 defined within the outer and inner frame members 16, 18 serve to contain each sliding blade 26 within the dedicated linear path 30 that prevents movement of each sliding blade 26 outside of this dedicated linear path 30.

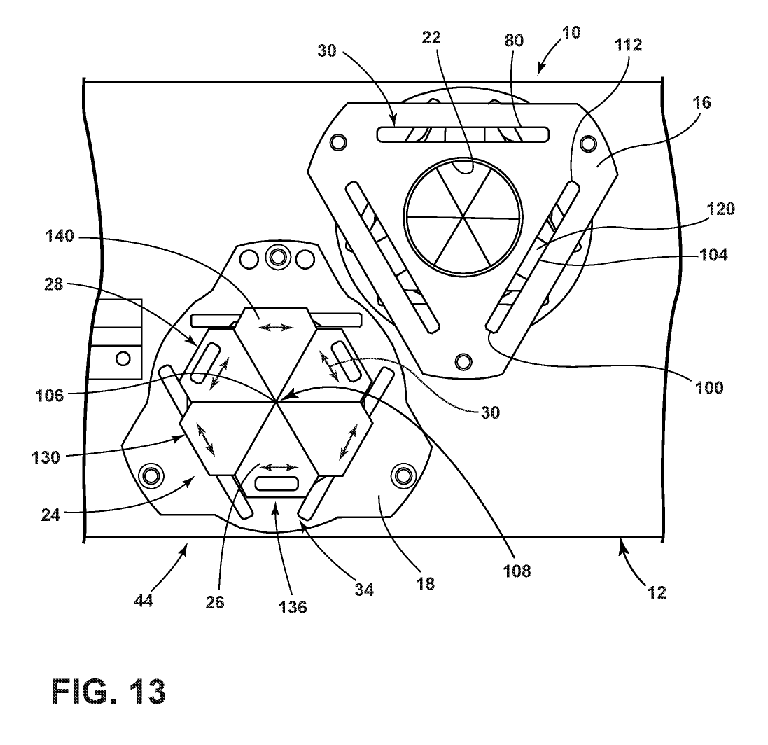

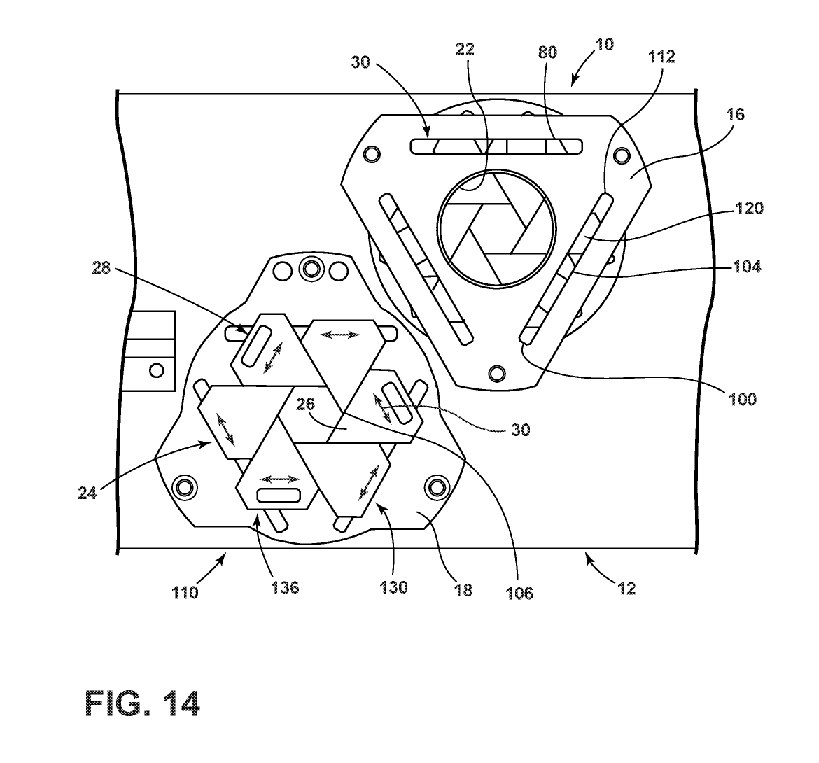

Referring again to FIGS. 11-15, operation of the iris separator 10 is defined by the distinct linear operation of each sliding blade 26 along each dedicated linear path 30 in the outward movement 46. The cooperation of the linear movements of each sliding blade 26 results in the simultaneous and coordinated movement of the various sliding blades 26 to define the first and second open states 40, 42 and the closed state 44 of the iris separator 10 as the sliding blades 26 move between the start position 32 to the end position 36 and back to the start position 32. At the start position 32 (shown in FIG. 11), each sliding blade 26 is positioned at a first end 100 of a corresponding guide slot 80. As each sliding blade 26 moves across the dedicated guide slot 80, each sliding blade 26 slidably operates against two adjacent sliding blades 26 to define the coordinated linear movements of each sliding blade 26 to move the sliding blades 26 towards the closed state 44. As exemplified by the partially closed state 102 of FIG. 12, each sliding blade 26 moves substantially the same distance through each corresponding guide slot 80. As the sliding blades 26 define the medial position 34 (shown in FIG. 13) where each sliding blade 26 is disposed at a mid-point 104 of each corresponding guide slot 80, the tips 106 of each sliding blade 26 meet or substantially meet at a center 108 of the aperture 22 to define the closed state 44 of the iris separator 10. At this point, one portion of the material stream 14 is separated from the remainder of the material stream 14, indicative of a cutting or segmenting operation. Again, each sliding blade 26 is adapted to slide against the two adjacent sliding blades 26 such that each sliding blade 26 is limited to a linear operation along each corresponding guide slot 80. As each sliding blade 26 moves to the partially open position 110 (shown in FIG. 14), each sliding blade 26 moves toward a second end 112 of each corresponding guide slot 80. Again, each sliding blade 26 is limited to a movement along its dedicated linear path 30 defined by each corresponding guide slot 80. Accordingly, FIGS. 10-14, sequentially, define one half of the reciprocal operation of the iris separator 10 in the outward movement 46. A progression of the iris separator 10 from FIG. 14 back through to FIG. 10, sequentially, defines the second half of the reciprocal operation of the iris separator 10 in the return movement 48.

Referring again to FIGS. 5-15, as discussed above, each sliding blade 26 is adapted to be in slidable engagement with two adjacent sliding blades 26 of the iris separator 10. It is contemplated that each sliding blade 26 of the first set 24 is adapted to engage, in a slidable fashion, the two adjacent sliding blades 26 that are each part of the second set 28 of sliding blades 26. Similarly, each sliding blade 26 of the second set 28 engages, in a slidable configuration, two adjacent sliding blades 26 that are each part of the first set 24 of sliding blades 26. This configuration accounts for the alternating placement of the sliding blades 26 of the first and second sets 24, 28 within the single sliding plane 90 within the sliding space 20. This alternate configuration of the sliding blades 26 of the first and second sets 24, 28 also accounts for the placement of the guide slot 80 within the outer and inner frame members 16, 18. It is contemplated that the various sliding blades 26 each include a guide tab 120 that extends at least partially through the corresponding guide slot 80 defined within the outer and inner frame members 16, 18. Accordingly, the guide tab 120 serves to limit any angular or rotational movement of the sliding blade 26 as it moves through the guide slot 80. Additionally, it is contemplated that each sliding blade 26 can be adapted to be in a generally triangular configuration. It is contemplated that the tips 106 of each sliding blade 26 can be adapted to meet at a center 108 of the aperture 22 when each of the sliding blades 26 defines the medial position 34 corresponding to the closed state 44 of the iris separator 10.

Referring again to FIGS. 5-15, in order to engage the radial actuator 60 with the sliding blades 26 of the first and second sets 24, 28, at least a portion of the sliding blades 26 are adapted to extend through either the inner frame member 18, the outer frame member 16, or both, where a portion of the guide tabs 120 extend through the corresponding guide slots 80 to engage the radial actuator 60. In such an embodiment, the sliding blades 26 of the first set 24 define drive blades 130 that directly engage the radial actuator 60. Each of the drive blades 130 can include a translating pin 132 that extends through the corresponding guide slot 80 and into respective translation slots 134 defined within the radial actuator 60. The sliding blades 26 of the second set 28 are spaced in an alternating configuration between the drive blades 130 are free of direct engagement with the radial actuator 60. Accordingly, the sliding blades 26 of the second set 28 define idler blades 136 that are moved in a sliding configuration by the drive blades 130. In operation, as the radial actuator 60 rotates to define each reciprocal rotation of the radial actuator 60, the translating pin 132 of the drive blades 130 is moved by the radial actuator 60 to operate the drive blades 130 along the dedicated linear path 30 for each drive blade 130.

According to the various embodiments, because the radial actuator 60 operates in a generally circular motion and each sliding blade 26 operates within a separate and dedicated linear path 30, the translating pin 132 of each drive blade 130 is adapted to at least partially slide through translation slots 134 of the radial actuator 60. In this manner, the sliding engagement between the translating pin 132 and the translation slot 134 serves to convert the rotational operation of the radial actuator 60 into linear operation of each drive blade 130.

Referring again to FIGS. 5-15, as each drive blade 130 moves along its corresponding dedicated linear path 30, the drive blades 130 slidably engage the idler blades 136 that are positioned in an alternating configuration, such that each drive blade 130 engages, and at least partially moves, two idler blades 136, and each idler blade 136 engages and is moved by two drive blades 130. Through this configuration, the motion of the drive blades 130 that is directly operated through the operation of the radial actuator 60 can, in turn, drive the motion of the idler blades 136 to define the first open state 40 and the closed state 44 and the second open state 42 of the iris separator 10 as it moves between the start position 32 and end position 36 and back to the start position 32 to define each reciprocal rotation of the radial actuator 60.

Referring now to FIG. 5, it is contemplated that among the drive blades 130 of the iris separator 10, one of the drive blades 130 can include a primary drive blade 131 that includes a primary translation pin 142 that passes through the corresponding primary guide slot 140, the translation slot 134 of the radial actuator 60, and also engages the linear actuator 70 for the segmenting mechanism 12. It is contemplated that the primary drive blade 131 can engage a corresponding guide slot 80 that is oriented parallel with the linear actuator 70. Accordingly, the linear operation of the linear actuator 70 is co-linear with the operation of the primary drive blade 131 through its corresponding guide slot 80. In this manner, the primary drive blade 131 and the linear actuator 70 can cooperate to manipulate the radial actuator 60 through each reciprocal rotation of the radial actuator 60 between the start position 32 and the end position 36 and back to the start position 32. It is also contemplated that the linear actuator 70 can include a separate connection mechanism with the radial actuator 60 such that the orientation of the guide slots 80 need not be co-linear with the operation of the linear actuator 70.

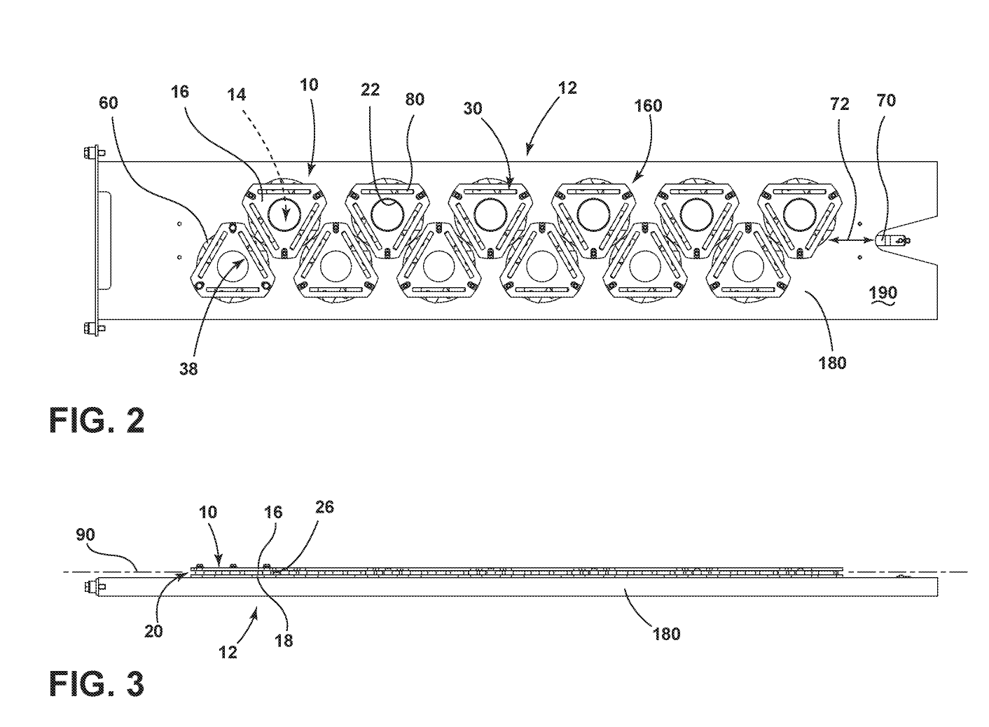

Referring again to FIGS. 2-16, in order to guide the operation of the linear actuator 70, a linear actuator guide 150 can be disposed at the end of the segmenting mechanism 12. The linear actuator guide 150 can include an actuating slot 152 through which the linear actuator 70 translates to operate the plurality of iris separators 10. It is contemplated that the segmenting mechanism 12 can include a single iris separator 10 or can include multiple iris separators 10, where a single linear actuator 70 can operate each of the iris separators 10 within the segmenting mechanism 12. It is contemplated that the linear actuator 70 can be operated through the use of several actuating mechanisms that can include, but are not limited to, servo motors, electric motors, piston-type motors, hydraulic drive mechanisms, pneumatic drive mechanisms, combinations thereof, and other similar drive mechanisms that can be adapted to linearly operate the linear actuator 70. It is also contemplated that the actuating mechanism can be activated and deactivated to time the reciprocal operation of the iris separator 10 to be coordinated with the flow of the extruded material stream 14. Accordingly, these considerations can result in the material stream 14 being sectioned, segmented, cut, or otherwise separated into predetermined thicknesses.

Referring again to FIGS. 1-4 and 17-20, the various aspects of the segmenting mechanism 12 can include various orientations and configurations of the plurality of iris separators 10 included therein. These orientations and configurations of the iris separators 10 can vary upon the configuration of the extruding and separating mechanism 8, the manner in which the extruded material streams 14 are delivered through the iris separators 10, the characteristics of the material streams 14, the desired final output resulting from operation of the iris separators 10, and other various considerations.

As exemplified in FIGS. 1-4, the iris separators 10, defined at least by a plurality of outer frame members 16, can be configured in a laterally staggered or alternating configuration. In such an embodiment, the linear actuator 70 can extend between laterally opposing banks 160 of iris separators 10. Accordingly, the linear actuator 70 will engage radial actuators 60 of each of the iris separators 10 that are positioned laterally and on either side of the linear actuator 70. In order for the linear actuator 70 to extend between the laterally opposing banks 160 of iris separators 10, the linear actuator 70 extends between the aligned apertures 22 of each of the laterally opposing banks 160 of iris separators 10 of the segmenting mechanism 12. The laterally opposing banks 160 of iris separators 10 can be coupled to a base member 180 onto which the inner frame member 18 of each iris separator 10 is coupled for securing the iris separator 10 to the base member 180. The apertures 22 for each distinct iris separator 10 are typically defined by openings defined within the base member 180. According to various aspects of the device, it is contemplated that the base member 180 can include an integrally formed guide slot 80 that is formed, ground, carved, or otherwise disposed within the base member 180. In such an embodiment, it is contemplated that the base member 180 serves as the inner frame member 18 and the various outer frame members 16 can be coupled to the base member 180 to define a sliding space 20 therebetween.

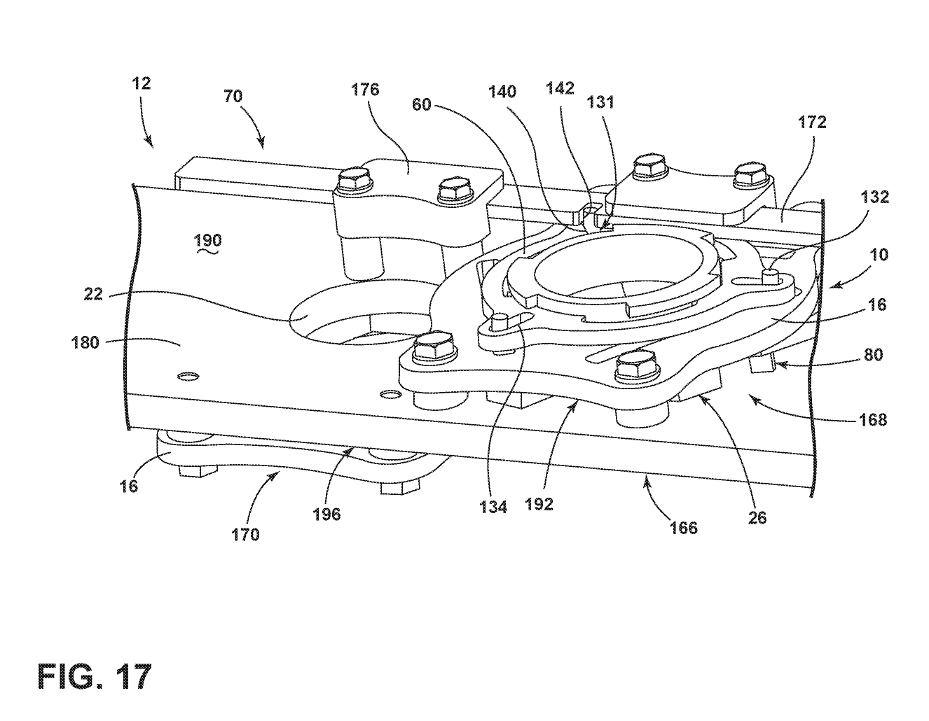

As exemplified in FIGS. 17-20, it is contemplated that the segmenting mechanism 12 can include the plurality of iris separators 10 in a vertically alternating configuration and that are aligned according to vertically opposing banks 166 of iris separators 10. In such an embodiment, a plurality of outer frame members 16 at least partially defines a corresponding plurality of iris separators 10. Each of the iris separators 10 of the vertically opposing banks 166 of iris separators 10 have apertures 22 that are aligned along and through the base member 180. In such an embodiment, an upper bank 168 of iris separators 10 is disposed above the base member 180 and a lower bank 170 of iris separators 10 is positioned below the base member 180. According to various aspects of the device, the linear actuator 70 may be positioned off to one side of the base member 180. The linear actuator 70 may include upper and lower linkages 172, 174 that engage each of the upper and lower banks 168, 170 of iris separators 10, respectively. Various linkage guides 176 can align the upper and lower linkages 172, 174 to provide a general linear motion of the linear actuator 70. The linkage guides 176 can cooperate with the linear actuator guide 150 and the actuating slot 152 to provide for linear motion of the linear actuator 70 and the upper and lower linkages 172, 174. The operation of each iris separator 10 and the first and second sets 24, 28 of sliding blades 26 operate in the manner consistent with that described herein. Additionally, it is contemplated that each iris separator 10 according to the aspect of the device as illustrated in FIGS. 17-20 can include outer and inner frame members 16, 18. It is also contemplated that the various iris separators 10 can include corresponding outer frame members 16 that are coupled to the base member 180. In such a configuration, the base member 180 integrally defines the various guide slots 80 for guiding the linear movement of various sliding blades 26 of the iris separator 10. While only two iris separators 10 are illustrated in the aspects of the device showing FIGS. 17-20, it is contemplated that additional members of iris separators 10 can be included in each of the vertically opposing banks 166 of iris separators 10.

Referring again to FIGS. 17-20, the base member 180 receives the upper bank 168 of iris separators 10 at a top surface 190 of the base member 180. In such an embodiment, an upper sliding space 192 is defined between the top surface 190 of the base member 180 and the outer frame member 16. Similarly, the lower bank 170 of iris separators 10 is coupled to a bottom surface 194 of the base member 180. A lower sliding space 196 is defined between the bottom surface 194 of the base member 180 and the outer frame members 16 of each iris separator 10 of the lower bank 170 of iris separators 10. Similar to the sliding space 20 described herein, the upper and lower sliding spaces 192, 196 contain the sliding blades 26 of the iris separators 10 in the upper and lower banks 168, 170, respectively.

It is contemplated that the various iris separators 10 for the segmenting mechanism 12 can include additional configurations and orientations of the various iris separators 10 that may be used to cooperate with the particular extruding and separating mechanism 8. In each of these configurations, it is contemplated that the operation of the sliding blades 26 of each iris separator 10 is substantially consistent with the operational characteristics described with respect to FIGS. 1-15.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. An iris separator comprising:
outer and inner frame members that define a sliding space and an aperture extending through the outer and inner frame members;
a first set of sliding blades that operate linearly within the sliding space and substantially proximate the aperture; and
a second set of sliding blades positioned in an alternating configuration with the first set of sliding blades, the second set of sliding blades also operating linearly within the sliding space proximate the aperture, wherein:
each sliding blade of the first and second sets of sliding blades operates within the sliding space along a dedicated linear path; and
the first and second sets of sliding blades cooperatively and simultaneously operate along each dedicated linear path from a start position, through a medial position to an end position, the start and end positions each defined by the sliding blades of the first and second sets of sliding blades being outside of the aperture to define respective first and second open states of the aperture, the medial position defined by the sliding blades of the first and second sets of sliding blades being at least partially within the aperture to define a closed state of the aperture.

2. The iris separator of claim 1, further comprising:
a radial actuator that engages at least one of the sliding blades, wherein a single reciprocal rotation of the radial actuator operates the first and second sets of sliding blades from the start position to the end position and back to the start position, the single reciprocal rotation defining two distinct occurrences of the closed state of the aperture.

3. The iris separator of claim 2, further comprising:
a linear actuator coupled to the radial actuator, wherein operation of the linear actuator along a linear drive path operates the radial actuator to define reciprocal rotations of the radial actuator.

4. The iris separator of claim 1, wherein each dedicated linear path is characterized by a distinct slot defined within at least one of the outer and inner frame members.

5. The iris separator of claim 1, wherein each sliding blade of the first set of sliding blades operates linearly through the inner frame member, and wherein each sliding blade of the second set of sliding blades operates linearly through the outer frame member.

6. The iris separator of claim 5, wherein the sliding blades of the first and second sets of sliding blades are disposed within and operate within a single sliding plane, the sliding plane being parallel with the inner and outer frame members.

7. The iris separator of claim 2, wherein the sliding blades extend through the inner frame member and directly engage the radial actuator.

8. The iris separator of claim 1, wherein the inner frame is a base member, and wherein the base member receives a plurality of outer frame members, each outer frame member of the plurality of outer frame members corresponding to a distinct iris separator of a plurality of iris separators.

9. The iris separator of claim 8, wherein the plurality of iris separators are positioned in a laterally alternating configuration on one side of the base member.

10. The iris separator of claim 8, wherein the plurality of iris separators are positioned in a vertically alternating configuration relative to the base member.

11. The iris separator of claim 8, wherein the base member includes a plurality of openings that correspond to the aperture of each distinct iris separator.

12. A segmenting mechanism comprising:
a base member having a plurality of openings defined therein;
a plurality of iris separators, wherein each iris separator is positioned at a dedicated opening of the plurality of openings, each iris separator comprising:
an outer frame member that partially defines a sliding space, the outer frame member including an aperture that aligns with a dedicated opening of the base member;
first and second sets of sliding blades that operate linearly within the sliding space and substantially proximate the aperture, wherein sliding blades of the first and second sets of sliding blades are positioned in an alternating configuration relative to the aperture; wherein:
each sliding blade of the first and second sets of sliding blades operates within the sliding space along a dedicated linear path; and
the first and second sets of sliding blades cooperatively and simultaneously operate along each dedicated linear path from a start position, through a medial position to an end position to sequentially define first open, closed and second open states of the aperture.

13. The segmenting mechanism of claim 12, wherein the start and end positions of the first and second sets of sliding blades are defined by the sliding blades of the first and second sets of sliding blades being outside of the aperture to define the first and second open states of the aperture.

14. The segmenting mechanism of claim 12, wherein the medial position is defined by the sliding blades of the first and second sets of sliding blades being at least partially within the aperture to define the closed state of the aperture.

15. The segmenting mechanism of claim 12, wherein the base member defines a portion of the sliding space.

16. The segmenting mechanism of claim 12, wherein each iris separator includes an inner frame member that is attached to the base member, wherein the inner and outer frame members cooperate to define the sliding space.

17. The segmenting mechanism of claim 12, wherein the plurality of iris separators are positioned relative to the base member to define laterally opposing banks of iris separators and vertically opposing banks of iris separators.

18. An iris separator comprising:
an outer frame member that partially defines a sliding space;
first and second sets of sliding blades that operate linearly within the sliding space and substantially proximate an aperture defined within the outer frame, wherein:
each sliding blade of the first and second sets of sliding blades operates along a dedicated linear path; and
the first and second sets of sliding blades cooperatively and simultaneously operate along each respective dedicated linear path from a start position corresponding to a first open state of the aperture, through a medial position corresponding to a closed state of the aperture and to an end position corresponding to a second open state of the aperture.

19. The iris separator of claim 18, wherein the first and second sets of sliding blades cooperatively and simultaneously operate along each respective dedicated linear path from the end position through the medial position and back to the start position, to define the second open, closed and first open states, respectively, of the aperture.

20. The iris separator of claim 19, wherein a linear actuator is coupled to at least one of the sliding blades, and wherein a single reciprocal operation of the linear actuator operates each of the sliding blades from the start position, through the medial position, to the end position, back through the medial position and back to the start position to define, sequentially, the first open state, the closed state, the second open state, back to the closed state and returning to the first open state of the aperture.
